(19) United States
(12) Patent Application Publication
(10) Pub. No.: US 2019/0265473 A1
(43) Pub. Date: Aug. 29, 2019

(54) APPARATUS, SYSTEMS, AND METHODS FOR ENABLING LOW-POWER COMMUNICATIONS VIA WEARERS' BODIES

(71) Applicant: Oculus VR, LLC, Menlo Park, CA (US)

(72) Inventor: Mohsen Shahmohammadi, Pittsburgh, PA (US)

(21) Appl. No.: 15/903,118

(22) Filed: Feb. 23, 2018

(51) Int. Cl. G02B 27/01; G06T 19/00

(52) U.S. Cl. CPC G02B 27/017; G02B 2027/014; G06T 19/006

(57) ABSTRACT

A head-mounted device may include (1) a data source that generates data, (2) a human-body coupler configured to apply body-bound carrier signals to a user's body and conduct body-bound carrier signals from the user's body, (3) a transmitting subsystem electrically connected to the human-body coupler and configured to (a) modulate a body-bound carrier signal with the data and (b) transmit, through the user's body via the human-body coupler, the data to an auxiliary processing device, (4) a receiving subsystem electrically connected to the human-body coupler and configured to (a) receive, through the user's body via the human-body coupler, an additional body-bound carrier signal from the processing device and (b) demodulate a result of processing the data from the additional body-bound carrier signal, and (5) an output device configured to output the result to the user. Various other apparatus, systems, and methods are also disclosed.

### BACKGROUND

This disclosure relates generally to wearable devices, and more specifically to head-mounted display devices and systems.

Virtual reality (VR) and augmented reality (AR) headsets are gaining in popularity for use in a growing number of activities. Such headsets may integrate visual information into a user's field of view to enhance their surroundings or allow them to step into immersive three-dimensional environments. While virtual reality and augmented reality headsets are often utilized for gaming and other entertainment purposes, they are also commonly employed for purposes outside of recreation-for example, governments may use them for military training simulations, doctors may use them to practice surgery, and engineers may use them as visualization aids. Virtual and augmented reality systems are also increasingly recognized for their utility in facilitating inter-personal interactions between individuals in a variety of contexts.

Head-mounted devices, such as virtual and augmented reality headsets, typically need to be light in weight and have small profiles. Because of weight and size constraints, conventional head-mounted devices have generally contained limited processing and power resources. Conventional head-mounted devices often rely on wired connections to external devices that perform graphics processing, sensor-data (e.g., image-data) processing, and/or other computational tasks for the head-mounted devices. Reliance on external devices for performing processing tasks may continue since these devices are likely to include more and more sensors that will generate data that must be processed (perhaps using machine-learning algorithms that consume more processing power than the processing power of conventional head-mounted devices). Unfortunately, wired connections may unsatisfactorily confine or encumber users' movements, especially in virtual and augmented reality contexts where immersive experiences are often desired. For at least this reason, some conventional head-mounted devices (e.g., smart glasses) are now wireless devices. Unfortunately, weight, size, and form-factor constraints of many of these wireless head-mounted devices leave little to no room for processing units, batteries needed for powering powerful processing units, or heat-removal units for cooling of powerful processing units, which typically leads to these devices having limited computation power, limited power budgets, and/or a need to charge these devices frequently. Some wearable devices have turned to low-power radio communication technologies (e.g., Bluetooth Low Energy (BLE) systems). However, these technologies may consume too much energy and/or have bandwidths or latencies that are too limiting for preferred designs of some wearable devices. The instant disclosure, therefore, identifies and addresses a need for apparatus, systems, and methods for enabling wireless low-power communications between wearable devices, especially virtual and augmented reality headsets and external processing devices.

### SUMMARY

As will be described in greater detail below, the instant disclosure describes various apparatus, systems, and methods for enabling wireless low-power communications and sharing of computational resources between devices worn or contacted by users. A head-mounted device may include (1) a data source that generates data, (2) a human-body coupler that includes a first electrode and a second electrode and that is configured to apply body-bound carrier signals to a user's body and conduct body-bound carrier signals from the user's body, (3) a transmitting subsystem electrically connected to the human-body coupler and configured to (a) modulate a body-bound carrier signal with the data and (b) transmit, through the user's body via the human-body coupler, the data to an auxiliary processing device for processing, (4) a receiving subsystem electrically connected to the human-body coupler and configured to (a) receive, through the user's body via the human-body coupler, an additional body-bound carrier signal from the auxiliary processing device and (b) demodulate a result of processing the data from the additional body-bound carrier signal, and (5) an output device configured to output the result to the user.

In some examples, the human-body coupler may be capacitively coupled to the user's body, and the head-mounted device may further include (1) a medial surface that faces the user's head when the head-mounted device is worn by the user and (2) a lateral surface that faces away from the user's head when the head-mounted device is worn by the user. In these examples, the first electrode may be coupled to the medial surface of the head-mounted device such that the first electrode contacts the user's head, and the second electrode may be coupled to the lateral surface of the head-mounted device such that the second electrode contacts air surrounding the user's body. Additionally or alternatively, the human-body coupler may be galvanically coupled to the user's body, and the head-mounted device may further include a medial surface that faces the user's head when the head-mounted device is worn by the user. In this example, the first electrode may be coupled to the medial surface of the head-mounted device such that the first electrode contacts the user's head, and the second electrode may be coupled to the medial surface of the head-mounted device such that the second electrode contacts the user's head.

In some examples, the head-mounted device may be a head-mounted display device. In at least one example, the head-mounted display device may further include a facial-interface cushion dimensioned to abut a facial portion of the user, and the first electrode may form an integral part of the facial-interface cushion. In at least one example, the output device may be a display, and the head-mounted display device may further include (1) a bridge coupled to the display and dimensioned to rest on the nose of the user and (2) a temple coupled to the display and dimensioned to rest on an ear of the user. In one example, the first electrode may form an integral part of the bridge or the temple. In some examples, the head-mounted device may be a smart contact lens configured to enhance the user's vision.

A wearable device may include (1) a data source that generates data, (2) at least one antenna configured to reflect ambient carrier signals from a user's environment into the user's body, (3) a backscatter modulator electrically connected to the antenna and configured to use an ambient carrier signal from the user's environment to backscatter, through the user's body via the antenna, the data to an auxiliary processing device. In some examples, the backscatter modulator may be further configured to frequency shift an initial frequency of the ambient carrier signal to a secondary frequency suitable for propagating through the user's body to the auxiliary processing device. In some examples, the secondary frequency may be between 1 kilohertz (kHz) and 100 megahertz (MHz), and the ambient carrier signal may include a frequency-modulated radio broadcast signal, an amplitude-modulated radio broadcast signal, a television broadcast signal, a wi-fi signal, a Bluetooth signal, an industrial, scientific and medical radio band signal, or a cellular radio signal.

In some examples, the wearable device may further include (1) a human-body coupler configured to conduct body-bound carrier signals from the user's body, (2) a receiving subsystem electrically connected to the human-body coupler and configured to (a) receive, through the user's body via the human-body coupler, a body-bound carrier signal from the auxiliary processing device and (b) demodulate a result of processing the data from the body-bound carrier signal, and (3) an output device configured to output the result to the user. In at least one example, the human-body coupler may be capacitively coupled to the user's body, and the wearable device may further include (1) a medial surface that faces the user's body when the wearable device is worn by the user and (2) a lateral surface that faces away from the user's body when the wearable device is worn by the user. In these examples the first electrode may be coupled to the medial surface of the wearable device such that the first electrode contacts the user's body, and the second electrode may be coupled to the lateral surface of the wearable device such that the second electrode contacts air surrounding the user's body. Additionally or alternatively, the human-body coupler may be galvanically coupled to the user's body, and the wearable device may further include a medial surface that faces the user's body when the wearable device is worn by the user. In this example, the first electrode may be coupled to the medial surface of the wearable device such that the first electrode contacts the user's body, and the second electrode may be coupled to the medial surface of the wearable device such that the second electrode contacts the user's body. In some examples, the wearable device may be a head-mounted display device. In at least one example, the wearable device may be a smart contact lens configured to enhance the user's vision.

A corresponding computer-implemented method may include (1) modulating, at a wearable device that includes at least one antenna configured to reflect ambient carrier signals into a user's body, a backscatter control signal with data generated at the wearable device and (2) transmitting the data from the wearable device to an auxiliary processing device by using, at the wearable device, the backscatter control signal to cause the antenna to backscatter an ambient carrier signal from the user's environment through the user's body. In some examples, the computer-implemented method may further include using the backscatter control signal to frequency shift an initial frequency of the ambient carrier signal to a secondary frequency suitable for propagating through the user's body to the auxiliary processing device. In some examples, the secondary frequency may be between 1 kilohertz and 100 megahertz, and the ambient carrier signal may include a frequency-modulated radio broadcast signal, an amplitude-modulated radio broadcast signal, a television broadcast signal, a wi-fi signal, a Bluetooth signal, an industrial, scientific and medical radio band signal, or a cellular radio signal.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary galvanically coupled data-exchanging system in accordance with some embodiments.

FIG. 2 is a block diagram of an exemplary capacitively coupled data-exchanging system in accordance with some embodiments.

FIG. 3 is a block diagram of an exemplary backscattering data-exchanging system in accordance with some embodiments.

FIG. 4 is a front view of a user wearing components of an exemplary data-exchanging system in accordance with some embodiments.

FIG. 5 is a front view of another user wearing components of another exemplary data-exchanging system in accordance with some embodiments.

FIG. 6 is a perspective top view of an exemplary head-mounted display device in accordance with some embodiments.

FIG. 7 is a perspective bottom view of the exemplary head-mounted display device illustrated in FIG. 6 in accordance with some embodiments.

FIG. 8 is a front view of exemplary electrodes of the exemplary head-mounted display device illustrated in FIG. 6 in accordance with some embodiments.

FIG. 9 is a perspective view of an exemplary head-mounted display device in accordance with some embodiments.

FIG. 10 is a perspective view of exemplary electrodes of the exemplary head-mounted display device illustrated in FIG. 9 in accordance with some embodiments.

FIG. 11A is a front view of an exemplary smart contact lens in accordance with some embodiments.

FIG. 11B is a cross-sectional view of the smart contact lens illustrated in FIG. 11A in accordance with some embodiments.

FIG. 12 is a model diagram of the smart contact lens illustrated in FIG. 11A in accordance with some embodiments.

FIG. 13 is a top view of an exemplary auxiliary processing device in accordance with some embodiments.

FIG. 14A is a perspective top view of an exemplary auxiliary processing device in accordance with some embodiments.

FIG. 14B is a perspective bottom view of the exemplary auxiliary processing device illustrated in FIG. 14A in accordance with some embodiments.

FIG. 15 is a flow diagram of an exemplary method for low-powered communications via wearers' bodies in accordance with some embodiments.

FIG. 16 is a flow diagram of an exemplary method for backscatter communications via wearers' bodies in accordance with some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to apparatus, systems, and methods for enabling wireless low-power communications and sharing of computational resources between devices worn or contacted by users. As will be explained in greater detail below, embodiments of the instant disclosure may enable a head-mounted device, such as a head-mounted display or a smart contact lens, to efficiently transmit data through a wearer's body to other remote processing devices (e.g., smart phones, smart watches, and/or laptop or desktop computers) worn or contacted by the wearer. By using a wearer's body as a low-loss communication medium, embodiments of the instant disclosure may enable wireless head-mounted devices to securely transmit and receive data using less power and at higher bandwidths when compared to devices that use only a wearer's environment (e.g., air surrounding the wearer) to transfer and receive data.

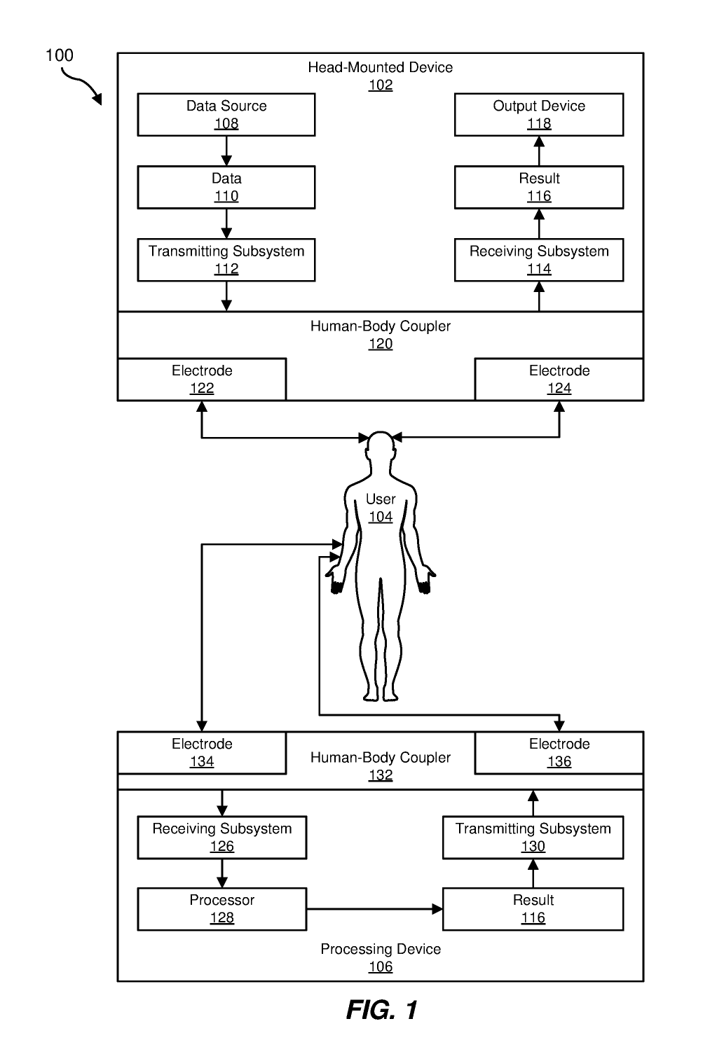

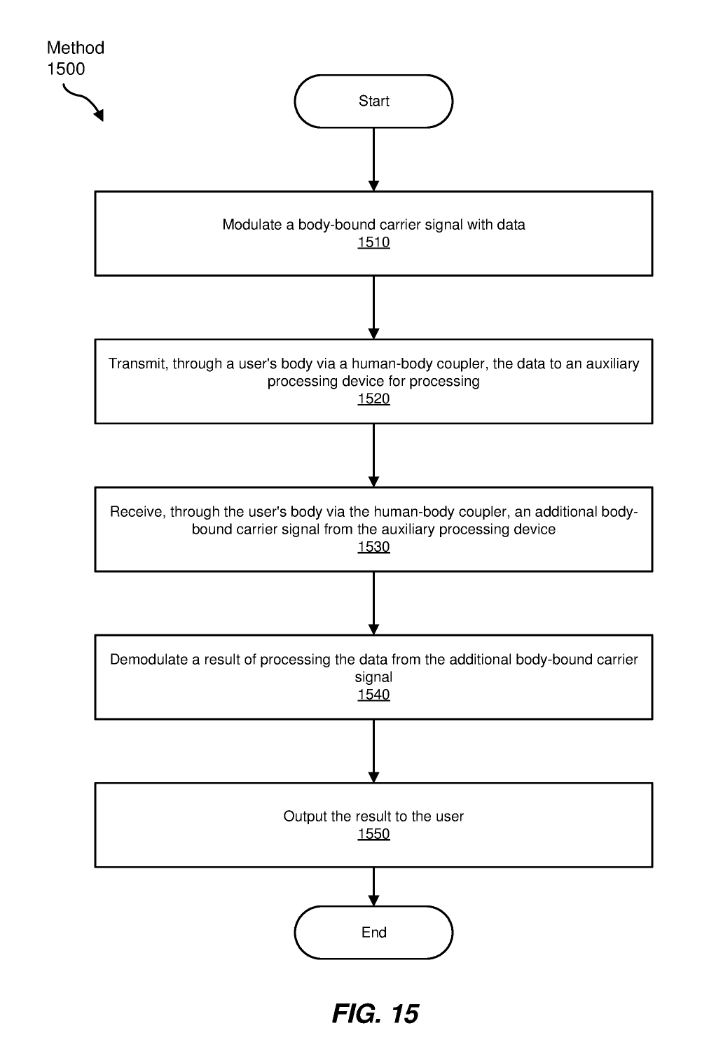

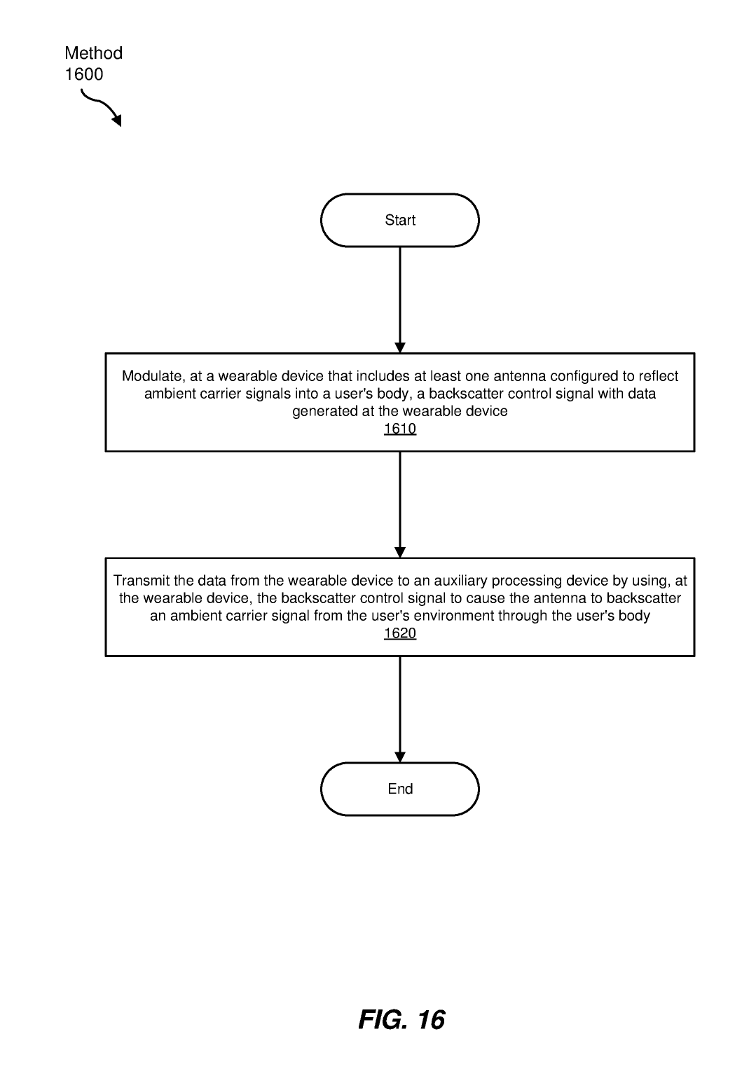

The following will provide, with reference to FIGS. 1-14B, examples of data-exchanging systems and devices. In addition, the discussion corresponding to FIGS. 15-16 will provide examples of methods for exchanging data via a wearer's body.

FIGS. 1-3 show exemplary data-exchanging systems for facilitating the transfer and/or reception of data between two devices that are worn or connected to a user's body according to some embodiments. As will be described in greater detail below, these data-exchanging systems may include one or more electronic devices (e.g., a head-mounted display device, a smart watch, a smart phone, etc.) that are worn by and/or interacted with by a user. In at least one embodiment, electronic devices of the data-exchanging systems may include electrodes and/or antennae that abut or are placed near body portions of the user to conduct or transmit body-bound carrier signals through the user's body. Such body-bound carrier signals may be utilized by the data-exchanging systems to transmit and receive data through the user's body.

FIG. 1 illustrates an exemplary galvanically coupled data-exchanging system 100. As shown in this figure, data-exchanging system 100 may include a head-mounted device 102 galvanically coupled to a processing device 106 via the body of a user 104. Head-mounted device 102 may include a data source 108 that produces data 110, and processing device 206 may include a processor 128 for processing data 110 into a result 116. In some embodiments, the term “data source” may refer to any electronic component that generates data. Examples of electronic components that produce data may include, without limitation, sensors (e.g., gyroscopic sensors, accelerometers, altimeters, global positioning system devices, light sensors, audio sensors, power sensors, high or low resolution cameras, etc.), input components (e.g., touch screens, buttons, joysticks, click wheels, scrolling wheels, touch pads, key pads, keyboards, data ports, etc.), processor components, data-storage components, and diagnostic components. In some embodiments, the term “processor,” may refer to any type or form of hardware-implemented processing unit capable of processing data (i.e., converting data from one form to another) by interpreting and/or executing computer-readable instructions. Examples of physical processors include, without limitation, microprocessors, microcontrollers, Central Processing Units (CPUs), Graphics Processing Units (GPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As shown in FIG. 1, head-mounted device 102 may include a transmitting subsystem 112 for transmitting data 110 to processing device 106, a receiving subsystem 114 for receiving body-bound carrier signals that have been transmitted by processing device 106 through the body of user 104, and an output device 118 (e.g., a visual display device, an audio device, a tactile-feedback device, etc.) for presenting result 116 to user 104. Processing device 106 may also include a receiving subsystem 126 for receiving body-bound carrier signals that have been transmitted by head-mounted device 102 through the body of user 104 and a transmitting subsystem 130 for transmitting result 116 (i.e., a result of processing data 110) to head-mounted device 102.

As shown in FIG. 1, head-mounted device 102 may include a human-body coupler 120 that galvanically couples head-mounted device 102 to the body of user 104. As shown, human-body coupler 120 may include two or more electrodes, such as electrode 122 and electrode 124, configured to conduct a body-bound carrier signal from the body of user 104 and/or apply a body-bound carrier signal to the body of user 104. Similarly, processing device 106 may include a human-body coupler 132 that galvanically couples processing device 106 to the body of user 104. As shown, human-body coupler 132 may include two or more electrodes, such as electrode 134 and electrode 136, configured to conduct a body-bound carrier signal from the body of user 104 and/or apply a body-bound carrier signal to the body of user 104. The term “electrode” may generally refer to any conductive surface. The electrodes described herein may have any suitable shape (e.g., square or circle) and/or may be made of any suitable conductive material (e.g., a conductive polymer, perhaps covered by silver ink, or a metal such as copper, silver, or gold).

In some examples, electrodes 122 and 124 may be disposed abutting a portion of the body of user 104 such that electrodes 122 and 124 are in relatively close proximity to each other without directly contacting each other. An electromagnetic signal that has been modulated to contain data 110 may be differentially applied between electrodes 122 and 124 by transmitting subsystem 112, generating an electric current between electrodes 122 and 124. A major portion of the electric current may be distributed between electrodes 122 and 124 and a smaller secondary electric current (i.e., a body-bound carrier signal) may propagate through the body of user 104. The body-bound carrier signal may be transmitted through conductive tissues of the body along any suitable pathway and/or combination of pathways in the body. The applied body-bound carrier signal may be received by electrodes 134 and 136 after passing through the body of user 104. According to some examples, electrodes 134 and 136 may abut a portion of the body of user 104 that is disposed apart from electrodes 122 and 124. Electrodes 134 and 136 may be positioned in relatively close proximity to each other without directly contacting each other. In at least one example, electrodes 134 and 136 may be separated from one another by a dielectric material. The secondary current induced by electrodes 122 and 124 may pass through at least a portion of body 104 as described above and may be received at electrodes 134 and 136, resulting in a differential signal being applied between electrodes 134 and 136, which may be received by receiving subsystem 126. Receiving subsystem 126 may demodulate this signal at processing device 106 to obtain data 110. In some embodiments, transmitting subsystem 130 may be similar to transmitting subsystem 112 and may transmit result 116 from processing device 106 to head-mounted device 102 in a similar manner. Likewise, receiving subsystem 114 may be similar to receiving subsystem 126 and may receive result 116 at head-mounted device 102 in a similar manner.

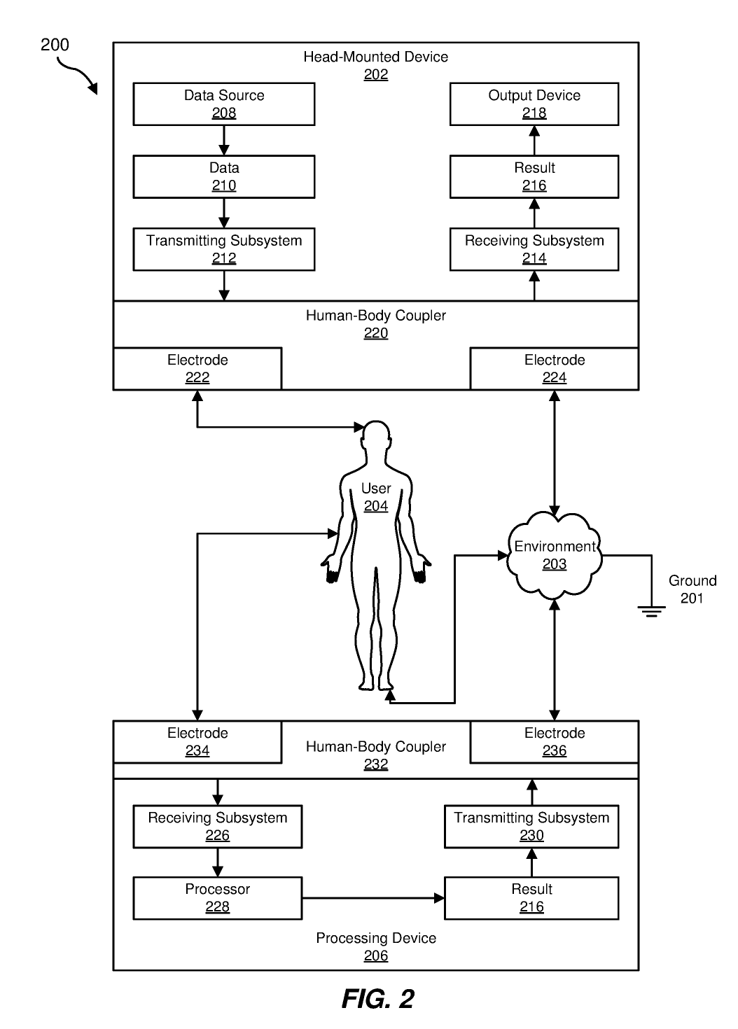

FIG. 2 illustrates an exemplary capacitively coupled data-exchanging system 200. As shown in this figure, data-exchanging system 200 may include a head-mounted device 202 capacitively coupled to a processing device 206 via the body of a user 204. Head-mounted device 202 may include a data source 208 that produces data 210, and processing device 206 may include a processor 228 for processing data 210 into a result 216.

As shown in FIG. 2, head-mounted device 202 may include a transmitting subsystem 212 for transmitting data 210 to processing device 206, a receiving subsystem 214 for receiving body-bound carrier signals that have been transmitted by processing device 206 through the body of user 204, and an output device 218 for presenting result 216 to user 204. Processing device 206 may also include a receiving subsystem 226 for receiving body-bound carrier signals that have been transmitted by head-mounted device 202 through the body of user 204 and a transmitting subsystem 230 for transmitting result 216 (i.e., a result of processing data 210) to head-mounted device 202.

As shown in FIG. 2, head-mounted device 202 may include a human-body coupler 220 that capacitively couples head-mounted device 202 to the body of user 204. As shown, human-body coupler 220 may include two or more plates or electrodes, such as electrode 222 and electrode 224, configured to conduct a body-bound carrier signal from the body of user 204 and/or apply a body-bound carrier signal to the body of user 204. Similarly, processing device 206 may include a human-body coupler 232 that capacitively couples processing device 206 to the body of user 204. As shown, human-body coupler 232 may include two or more plates or electrodes, such as electrode 234 and electrode 236, configured to conduct a body-bound carrier signal from the body of user 204 and/or apply a body-bound carrier signal to the body of user 204.

In some embodiments, human-body coupler 220 may be capacitively coupled to the body of user 204 and to a region surrounding the user, represented by environment 203, via one or more electrodes, such as electrodes 222 and 224, and human-body coupler 232 may be capacitively coupled to the body of user 204 and to a region surrounding the user, represented by environment 203, via one or more electrodes, such as electrodes 234 and 236. As shown in FIG. 2, electrode 222 may point towards and abut a portion of the body of user 204, and electrode 224 may point away from the body of user 204 and be exposed to environment 203. Electrodes 222 and 224 may be in relatively close proximity to each other and may be electrically isolated from one another by a dielectric material. For example, electrode 222 and electrode 224 may be layered so as to overlap each other with a dielectric layer disposed between electrode 222 and electrode 224. Additionally, electrode 224, which is exposed to environment 203, may not contact the body of user 204 such that electrodes 222 and 224 are each disposed at different distances from the body, resulting in electrodes 222 and 224 each having a different capacitive coupling to the body when an electromagnetic signal that has been modulated to include data 210 is applied between electrodes 222 and 224 by transmitting subsystem 212. A corresponding body-bound carrier signal may be applied to the body of user 204 by electrodes 222 and 224.

In some embodiments, electrode 234 may also abut a portion of the body of user 204, and electrode 236 may be exposed to environment 203 as illustrated in FIG. 2. Electrodes 234 and 236 may be in relatively close proximity to each other and may be separated from one another by a dielectric material. For example, electrode 234 and electrode 236 may be layered so as to overlap each other with a dielectric layer disposed between electrode 234 and electrode 236. Additionally, electrode 236, which is exposed to environment 203, may not contact the body of user 204. Accordingly, electrodes 234 and 236 may each be disposed at different distances from the body of user 204 such that differential signals are generated between electrodes 234 and 236 in response to the body-bound carrier signal applied via electrodes 222 and 224 passing through the body of user 204. The body of user 204 may, for example, act as a conductor conveying the body-bound carrier signals from transmitting subsystem 212 via electrodes 222 and 224 to receiving subsystem 226 via electrodes 234 and 236. A return signal path may be generated between electrode 224 and electrode 236, which are exposed to environment 203, through ground 201. Therefore, an electric field around the body of user 204 may be utilized to capacitively transmit a body-bound carrier signal that has been modulated to contain data 210 through the body of user 204 from transmitting subsystem 212 to receiving subsystem 226. Receiving subsystem 226 may demodulate this signal at processing device 206 to obtain data 210. In some embodiments, transmitting subsystem 230 may be similar to transmitting subsystem 212 and may transmit result 216 from processing device 206 to head-mounted device 202 in a similar manner. Likewise, receiving subsystem 214 may be similar to receiving subsystem 226 and may receive result 216 at head-mounted device 202 in a similar manner.

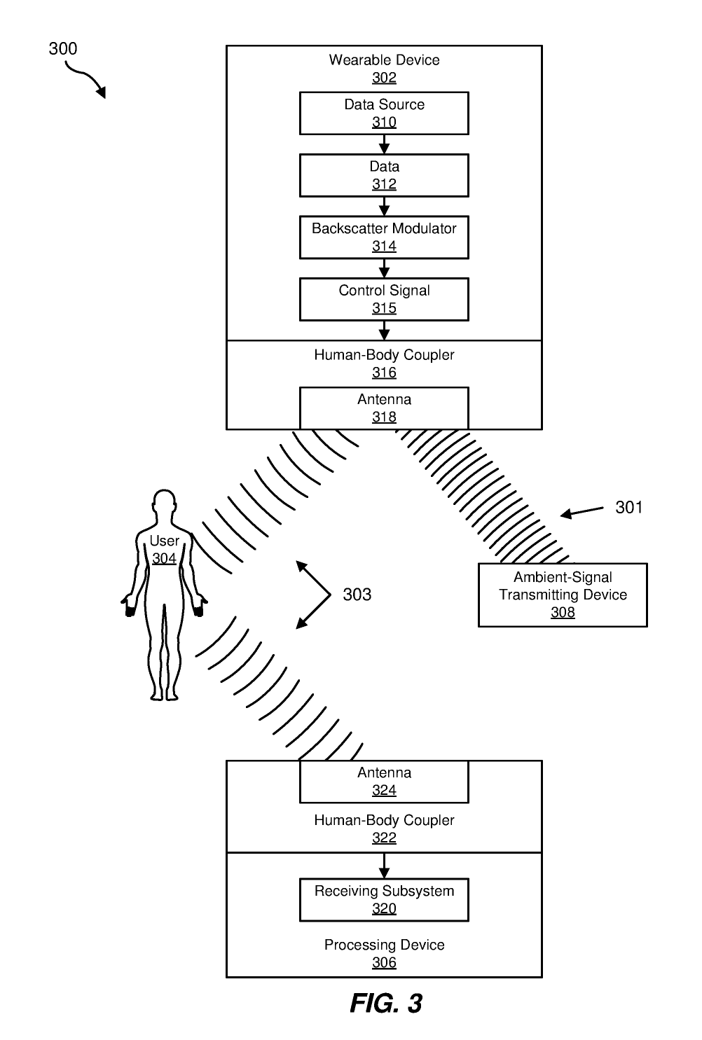

FIG. 3 illustrates an exemplary data-exchanging system 300. As shown in this figure, data-exchanging system 300 may include a wearable device 302 (e.g., a head-mounted device) communicatively coupled to a processing device 306 via the body of a user 304. Wearable device 302 may include a data source 310 that produces data 312. As shown in FIG. 3, wearable device 302 may include a backscatter modulator 314 for transmitting data 312 to processing device 306, and processing device 306 may include a receiving subsystem 320 for receiving body-bound carrier signals that have been transmitted by wearable device 302 through the body of user 304.

As shown in FIG. 3, wearable device 302 may include a human-body coupler 316 that couples wearable device 302 to the body of user 304. As shown, human-body coupler 316 may include one or more antennae, such as antenna 318, configured to reflect an ambient carrier signal 301 into the body of user 304. Processing device 306 may also include a human-body coupler 322 that couples processing device 306 to the body of user 304. As shown, human-body coupler 322 may include one or more antennae, such as antenna 324, configured to receive a body-bound carrier signal from the body of user 304.

In the example shown in FIG. 3, ambient carrier signal 301 may represent a carrier signal transmitted by an ambient-signal transmitting device 308 into the environment of user 304, and body-bound carrier signal 303 may represent a backscattered reflection of ambient carrier signal 301 that passes through the body of user 304. In some examples, the term “ambient carrier signal” may refer to any electromagnetic radiation that falls within the radio spectrum (e.g., electromagnetic radiation with frequencies between about 9 hertz (Hz) and 300 gigahertz (GHz)) that has been transmitted into a user's environment. In some embodiments, the term “ambient carrier signal” may refer to electromagnetic radiation that has been transmitted into a user's environment for a purpose other than being reflected into a user's body. Alternatively, the term “ambient carrier signal” may refer to electromagnetic radiation that has been transmitted into a user's environment for the purpose of being used to transmit data through the user's body. Examples of ambient carrier signals may include, without limitation, Frequency-Modulated (FM) radio broadcast signals, Amplitude-Modulated (AM) radio broadcast signals, Television (TV) broadcast signals, wi-fi signals, Bluetooth signals, Industrial, Scientific And Medical (ISM) radio band signals, cellular radio signals, radar signals, Radio-Frequency Identification (RFID) signals, and/or any other suitable radio-wave signals. As such, ambient-signal transmitting device 308 may represent any device or system that generates one or more of the above mentioned ambient carrier signals. Examples of ambient-signal transmitting device 308 may include, without limitation, FM and AM radio broadcasting towers, TV broadcasting towers, cell towers, wi-fi access points, wi-fi client devices, Bluetooth client devices, and/or radar towers.

In some examples, antenna 318 may be disposed abutting a portion of the body of user 304. Backscatter modulator 314 may use an electromagnetic backscatter control signal 315 that has been modulated to carry data 312 and/or frequency shift ambient carrier signal 301 to modulate the load impedance of antenna 318, resulting in ambient carrier signal 301 being reflected into the body of user 304 as body-bound carrier signal 303. In this example, the modulation of the load impedance of antenna 318 may modulate body-bound carrier signal 303 to carry data 312. Body-bound carrier signal 303 may then propagate through the body of user 304 to antenna 324. According to some examples, antenna 324 may abut a portion of the body of user 304 that is disposed apart from antenna 318. Body-bound carrier signal 303 may pass through at least a portion of the body of user 304 as described above until it is absorbed by antenna 324 and received by receiving subsystem 320. Receiving subsystem 320 may demodulate this signal at processing device 306 to obtain data 312.

In some embodiments, signals applied to the body of a user by one or more electrodes or antennae may be selected such that body-bound carrier signals do not negatively impact a user's health while allowing for sufficient propagation of the body-bound carrier signals through the user's body. For example, a transmitting subsystem (e.g., transmitting subsystem 112, transmitting subsystem 212, backscatter modulator 314, etc.), may supply between about 0 to −50 decibel-milliwatts (dBm) of power to electrodes or antennae at frequencies between about 1 kilohertz (kHz) and 150 megahertz (MHz).

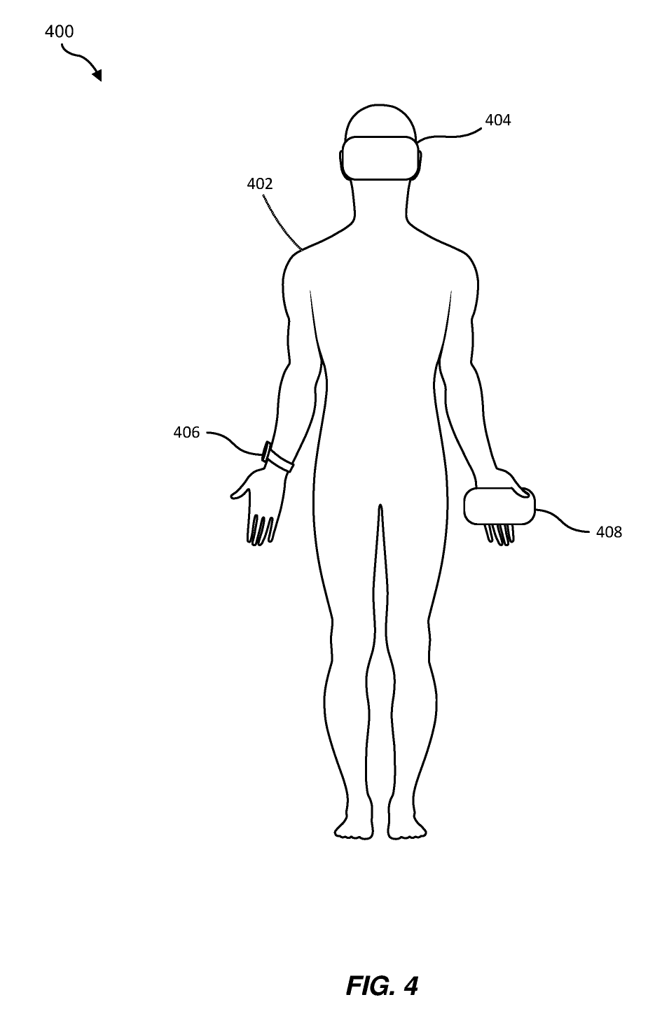

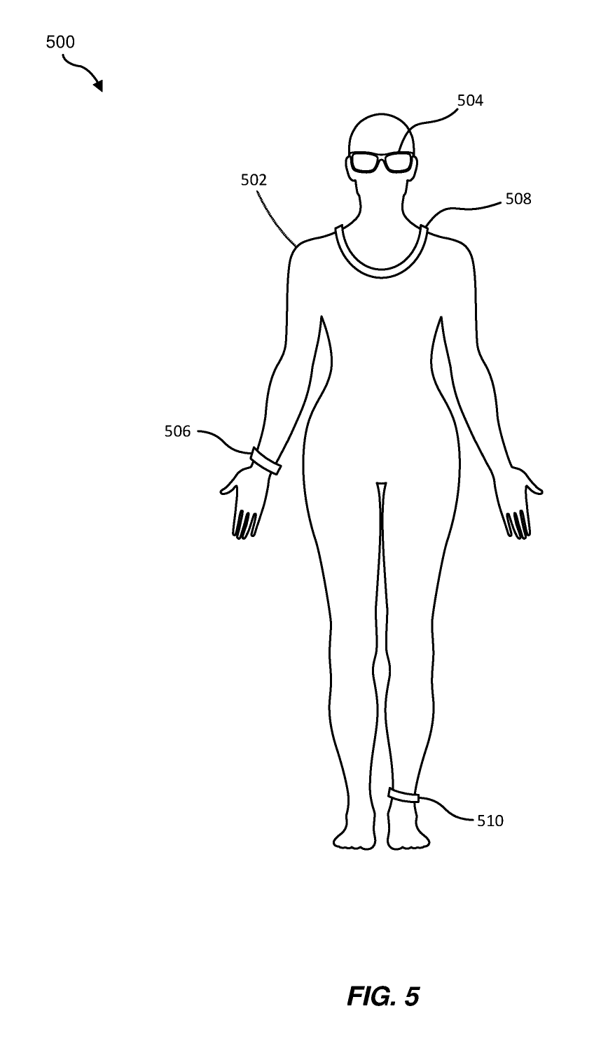

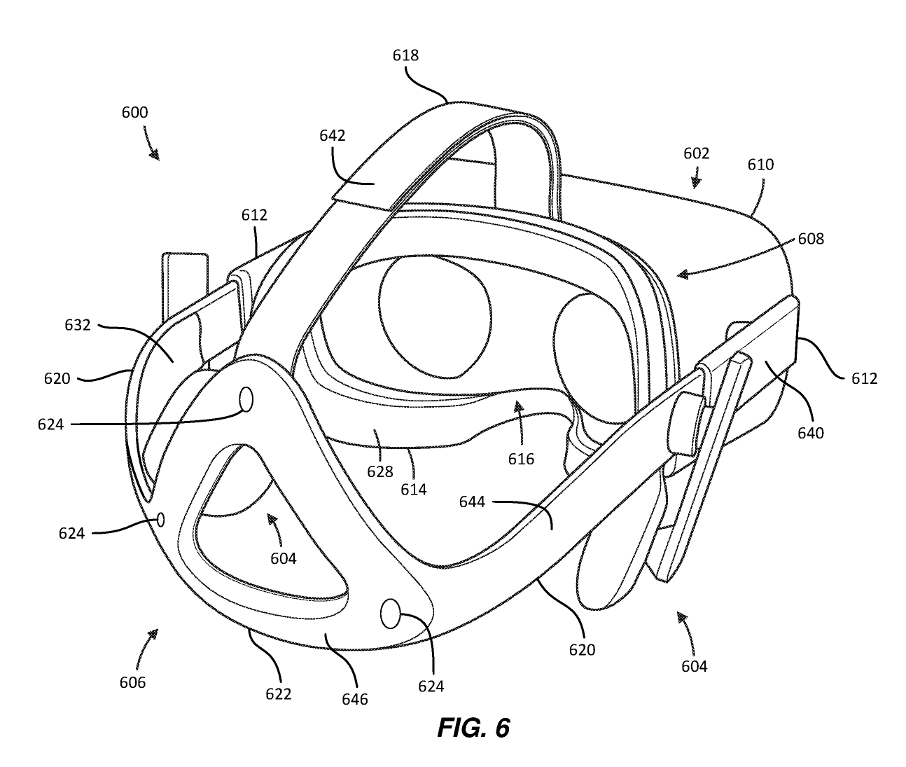

Example data-exchanging systems 100, 200, and 300 in FIGS. 1, 2, and 3 may be implemented in a variety of ways. For example, all or a portion of example data-exchanging systems 100, 200, and 300 may represent portions of example systems 400 and 500 shown in FIGS. 4 and 5. As shown in FIG. 4, data-exchanging system 400 may include a user 402 and various data-generating and/or processing devices that are worn or held by user 402. For example, FIG. 4 illustrates a head-mounted display system 404, such as head-mounted display system 600 illustrated in FIGS. 6-8, worn on the head of user 402, a smart watch 406 worn on a wrist of user 402, and a smart phone 408 held in a hand of user 402. In some examples, head-mounted display system 404 may include a data source that generates data and may galvanically and/or capacitively transmit body-bound carrier signals containing the data to smart watch 406 and/or smart phone 408 for processing, via electrodes of head-mounted display system 404, smart watch 406, and/or smart phone 408. Additionally or alternatively, head-mounted display system 404 may backscatter ambient carrier signals containing the data through the body of user 402 to smart watch 406 and/or smart phone 408 for processing, via antennae of head-mounted display system 404, smart watch 406, and/or smart phone 408. In these examples, smart watch 406 and/or smart phone 408 may include a processor configured to process the data and may galvanically and/or capacitively transmit body-bound carrier signals containing a result of processing the data to head-mounted display system 404, via electrodes of head-mounted display system 404, smart watch 406, and/or smart phone 408.

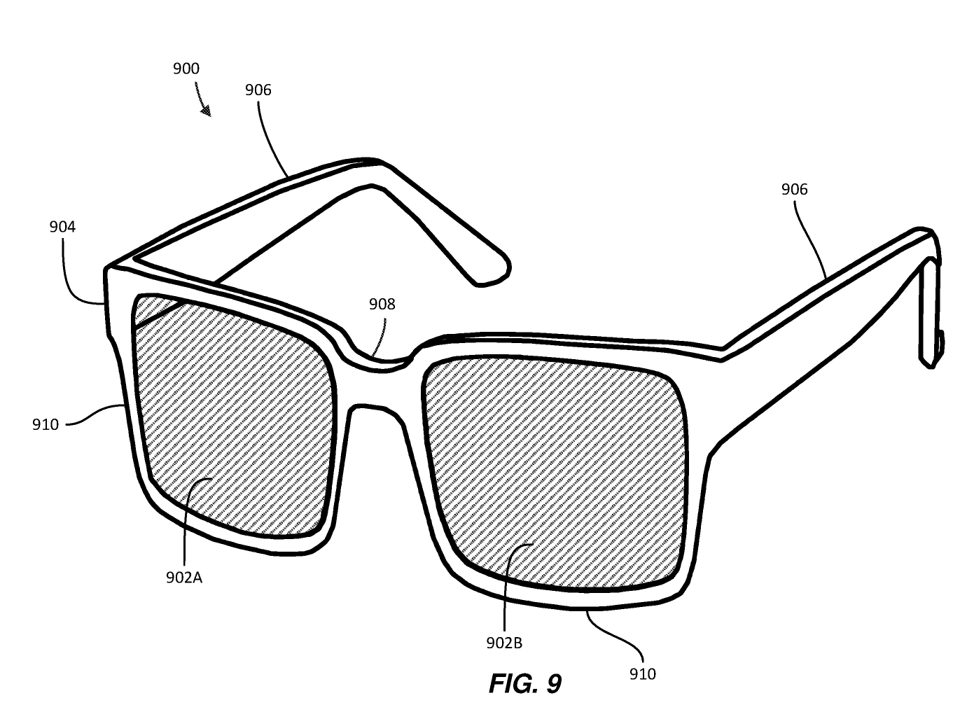

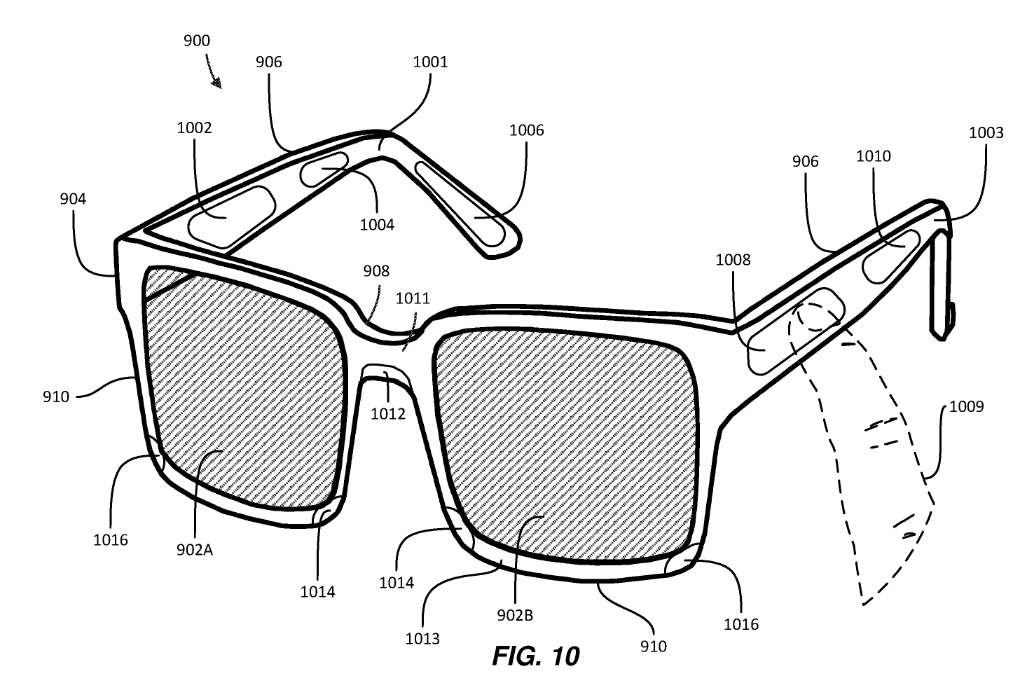

As shown in FIG. 5, data-exchanging system 500 may include a user 502 and various data- and processing devices that are worn or held by user 502. For example, FIG. 5 illustrates a head-mounted display device 504, such as head-mounted display device 900 illustrated in FIGS. 9 and 10, worn on the head of user 502, an electronic device 506 worn on a wrist of user 502, an electronic device 508 worn about neck region of user 502, and an electronic device 510 worn on an ankle of user 502. In some examples, head-mounted display system 504 may include a data source that generates data and may galvanically and/or capacitively transmit body-bound carrier signals containing the data to electronic device 506, electronic device 508, and/or electronic device 510 for processing, via electrodes of head-mounted display system 504, electronic device 506, electronic device 508, and/or electronic device 510. Additionally or alternatively, head-mounted display system 504 may backscatter ambient carrier signals containing the data through the body of user 502 to electronic device 506, electronic device 508, and/or electronic device 510 for processing, via antennae of head-mounted display system 504, electronic device 506, electronic device 508, and/or electronic device 510. In these examples, electronic device 506, electronic device 508, and/or electronic device 510 may include a processor configured to process the data and may galvanically and/or capacitively transmit body-bound carrier signals containing a result of processing the data to head-mounted display system 504, via electrodes of head-mounted display system 504, electronic device 506, electronic device 508, and/or electronic device 510.

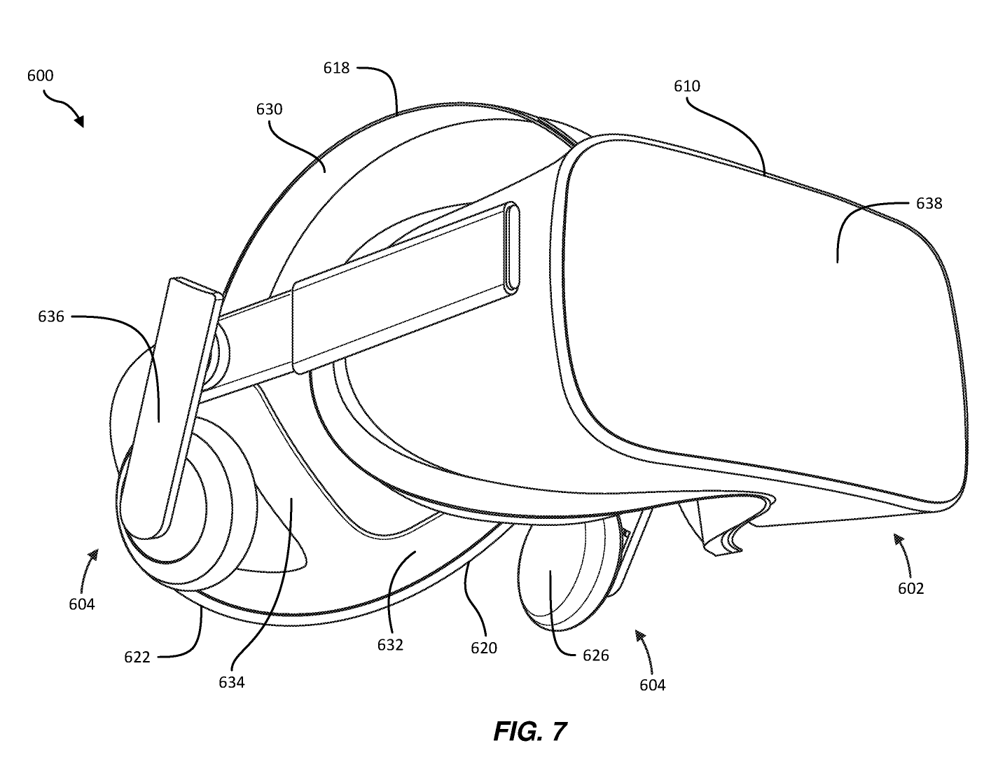

FIGS. 6 and 7 are perspective views of a head-mounted display system 600 in accordance with some embodiments. Head-mounted display system 600 includes a head-mounted display device 602 (e.g., a head-mounted display), audio subsystems 604, a strap assembly 606, and a facial-interface subsystem 608. In some embodiments, the term “head-mounted display” may refer to any type or form of display device or system that is worn on or about a user's head and displays visual content to a user. Head-mounted displays may display content in any suitable manner, including via a screen (e.g., an LCD or LED screen), a projector, a cathode ray tube, an optical mixer, etc. Head-mounted displays may display content in one or more of various media formats. For example, a head-mounted display may display video, photos, and/or computer-generated imagery (CGI).

Head-mounted displays may provide diverse and distinctive user experiences. Some head-mounted displays may provide virtual-reality experiences (i.e., they may display computer-generated or pre-recorded content), while other head-mounted displays may provide real-world experiences (i.e., they may display live imagery from the physical world). Head-mounted displays may also provide any mixture of live and virtual content. For example, virtual content may be projected onto the physical world (e.g., via optical or video see-through), which may result in augmented reality or mixed reality experiences.

In some embodiments, head-mounted display device 602 may include an outer housing 610 that may surround, contain, and protect various display, optical, and other electronic components of head-mounted display device 602. Outer housing 610 may be attached to strap assembly 606 by interfaces 612. Facial-interface subsystem 608 may be configured to comfortably rest against a region of a user's face, including a region surrounding the user's eyes, when head-mounted display system 600 is worn by the user. In these embodiments, facial-interface subsystem 608 may include a facial-interface cushion 614. Facial-interface cushion 614 may surround a viewing region 616 that includes the user's field of vision while the user is wearing head-mounted display system 600.

In some embodiments, strap assembly 606 may be used to mount head-mounted display device 602 on a user's head. As shown in FIG. 6, strap assembly 606 may include an upper strap 618 and lower straps 620. Lower straps 620 may each be coupled to one of strap interfaces 612, which are shown coupled to head-mounted display device 602. Strap assembly 606 may adjustably conform to the top and/or sides of a user's head when the user is wearing head-mounted display device 602. In some embodiments, strap assembly 606 may include a back piece 622 coupled with upper strap 618 and lower straps 620 to rest against the back of the user's head (e.g., around the user's occipital lobe).

Strap assembly 606 may include various electronic components that may generate and/or display data. As shown in FIG. 6, strap assembly 606 may include motion-tracking lights 624 integrated into back piece 622 and audio subsystems 604 coupled to lower straps 620. In some embodiments, motion-tracking lights 624 may be light-emitting-diode markers that are used by an external motion-tracking system to track the position and/or motion of head-mounted display system 600.

Electrodes and antennae made of various conductive elements for transmitting and receiving data via a user's body (such as electrodes 122, 124, 134, and 136 in FIG. 1, electrodes 222, 224, 234, and 236 in FIG. 2, and antennae 318 and 324 in FIG. 3) may be incorporated into head-mounted display system 600. Conductive elements may be incorporated into any suitable medial or lateral surface of head-mounted display system 600. The term “medial surface” may refer to any surface of a wearable device that faces or points towards a user's body, and the term “lateral surface” may refer to any surface of a wearable device that faces a user's environment and/or face's away from the user's body. In some examples, the medial surfaces of head-mounted display system 600 may include one or more conductive elements positioned to rest against or near a user's head, face, or ears. For example, conductive elements may be incorporated into some or all of medial surfaces 626 of audio subsystems 604, a medial surface 628 of facial-interface subsystem 608, a medial surface 630 of upper strap 618, medial surfaces 632 of lower straps 620, and/or a medial surface 634 of back piece 622. In some examples, the lateral surfaces of head-mounted display system 600 may include one or more conductive elements positioned to face away from a user's head. For example, conductive elements may be incorporated into some or all of lateral surfaces 636 of audio subsystems 604, a lateral surface 638 of outer housing 610, lateral surfaces 640 of strap interfaces 612, a lateral surface 642 of upper strap 618, lateral surfaces 644 of lower straps 620, and/or a lateral surface 646 of back piece 622.

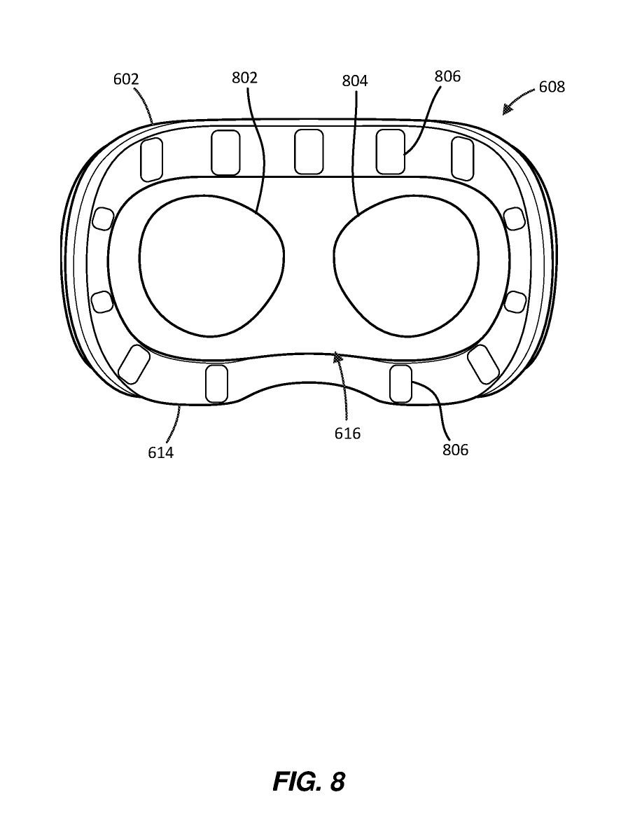

FIG. 8 is a front view of an exemplary head-mounted display device in accordance with some embodiments. Head-mounted display devices may include facial interfaces having electrodes or antennae of a human-body coupler as described herein. Such facial interfaces may include any suitable number of electrodes or antennae having any suitable size, shape, and configuration. According to at least one embodiment, as shown in FIG. 8, head-mounted display device 602 may include facial-interface subsystem 608 surrounding a viewing region 616, which includes a user's field of vision, allowing the user to look through left-eye lens 802 and right-eye lens 804 of head-mounted display device 602 without interference from outside light while the user is wearing head-mounted display device 602. Images displayed by one or more display screens of head-mounted display device 602 may be visible to a user through left-eye lens 802 and right-eye lens 804.

As illustrated in FIG. 8, facial-interface subsystem 608 may also include a plurality of electrodes and/or antennae 806 that are positioned to abut various regions of a user's face when head-mounted display device 602 is worn by the user. For example, as will be described in greater detail below, electrodes and/or antennae 806 may be positioned to abut portions of the user's nasal, cheek, temple, and/or forehead facial regions. In at least one embodiment, one or more of electrodes and/or antennae 806 may be elongated electrodes and/or antennae having a rectangular or generally rectangular periphery, as shown in FIG. 8. In some examples, electrodes and/or antennae 806 may be disposed in a facial-interface cushion 614 of facial-interface subsystem 608 such that surfaces of electrodes and/or antennae 806 are positioned to abut the user's face. Electrodes and/or antennae 806 may be positioned apart from each other such that adjacent electrodes and/or antennae 806 do not contact each other. In some examples, facial-interface cushion 614 may include an insulative material that prevents an electrical current from being conducted between separate electrodes and/or antennae 806 via facial-interface cushion 614.

In some examples, electrodes and/or antennae 806 may be galvanically or capacitively coupled to a user when head-mounted display device 602 is worn by the user such that body-bound carrier signals may be transmitted to or received from two or more electrodes of another electronic device mounted to a separate portion of the user's body. Additionally or alternatively, electrodes and/or antennae 806 may be coupled to a user when head-mounted display device 602 is worn by the user such that ambient carrier signals may be backscattered to one or more antennae of another electronic device mounted to a separate portion of the user's body. Electrodes and/or antennae 806 may be configured to receive or transmit body-bound carrier signals when electrodes and/or antennae 806 contact a user's skin and/or when electrodes and/or antennae 806 are in sufficiently close proximity to the user's skin.

FIGS. 9 and 10 are diagrams of a head-mounted display device 900 according to some embodiments. The depicted embodiment includes a right near-eye display 902A and a left near-eye display 902B, which are collectively referred to as near-eye displays 902. Near-eye displays 902 may present media to a user. Examples of media presented by near-eye displays 902 include one or more images, a series of images (e.g., a video), audio, or some combination thereof. Near-eye displays 902 may be configured to operate as an AR near-eye display, such that a user can see media projected by near-eye displays 902 and see the real-world environment through near-eye displays 902. However, in some embodiments, near-eye displays 902 may be modified to also operate as VR near-eye displays, MR near-eye displays, or some combination thereof. Accordingly, in some embodiments, near-eye displays 902 may augment views of a physical, real-world environment with computer-generated elements (e.g., images, video, sound, etc.).

As shown in FIG. 9, head-mounted display device 900 may include a support or frame 904 that secures near-eye displays 902 in place on the head of a user, in embodiments in which near-eye displays 902 include separate left and right displays. In some embodiments, frame 904 may be a frame of eye-wear glasses. Frame 904 may include temples 906 configured to rest on the top of and/or behind a user's ears, a bridge 908 configured to rest on the top on the bridge of the user's nose, and rims 910 sized and configured to rest on or against the user's cheeks. Although not illustrated in FIG. 9, in some embodiments, head-mounted display device 900 may include nose pads for resting on the bridge of the user's nose.

Conductive elements for transmitting and receiving data via a user's body may be incorporated into head-mounted display device 900 at various locations. In some examples, two or more of these conductive elements may be used as antennae pairs for transmission or reception of data. FIG. 10 illustrates exemplary placements of conductive elements for head-mounted display device 900. In this example, a medial surface 1001 of one or both of temples 906 may include a conductive element 1002 positioned to rest against or near the temple region of a user's face, a conductive element 1004 positioned to rest against or near the region of a user's head above the user's ear, and/or a conductive element 1006 positioned to rest against or near the region of a user's head behind the user's ear. In some examples, a medial surface 1011 of bridge 908 may include a conductive element 1012 configured to rest on the top on the bridge of the user's nose, and/or a medial surface 1013 of rims 910 may include conductive elements 1014 and 1016 configured to rest against the user's cheeks. A lateral surface 1003 of one or both of temples 906 may include a conductive element 1008 positioned near the temple region of a user's face such that a user is able to touch or contact conductive element 1008 with a finger 1009 (which may enable data to be transferred through a user's hand and arm) and/or a conductive element 1010 positioned to rest against or near the top of the user's ear. In embodiments where head-mounted display device 900 has nose pads, some or all of the nose pads may include conductive elements for transmitting or receiving data via a user's body.

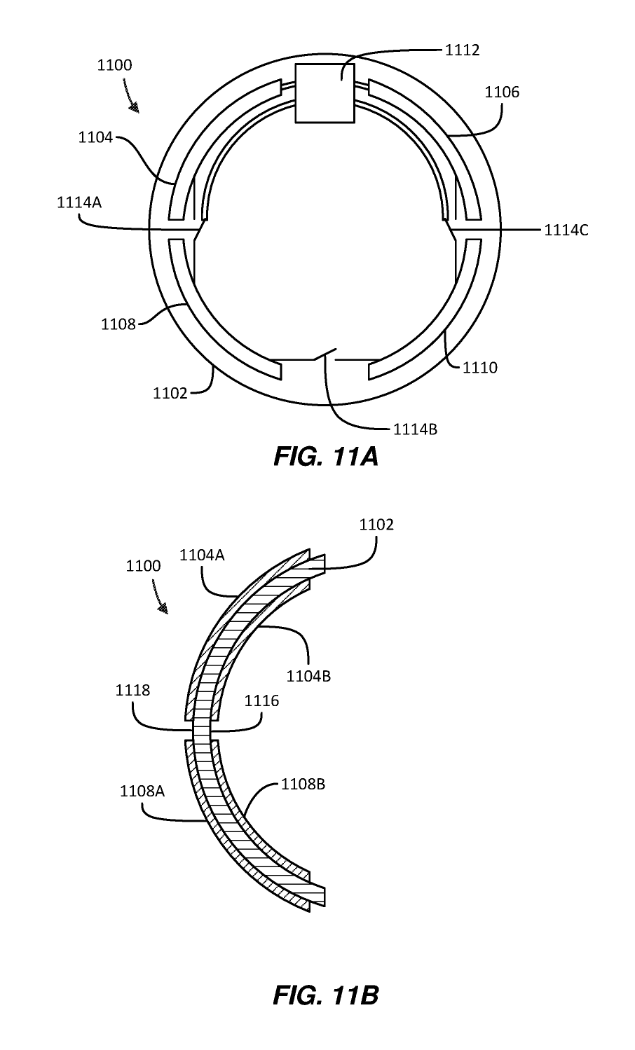

FIGS. 11A and 11B are a front and a cross-sectional view, respectively, of a smart contact lens 1100 (e.g., for correcting a user's vision, displaying images to the user, recording images viewed by the user, monitoring physiological parameters, like blood sugar, or vital signals, etc.) according to some embodiments. As shown by the depicted embodiment, smart contact lens 1100 may include a dielectric substrate 1102 (e.g., a dielectric material such as plastic, glass, etc.), two or more electrodes and/or antennae (e.g., electrodes and/or antennae 1104, 1106, 1108, and/or 1110) for receiving power via a user's body, and circuitry 1112 (e.g., an electronic component, a transmitting subsystem, a receiving subsystem, and/or other control systems for managing smart contact lens 1100). In some embodiments, electrodes and/or antennae 1104-1110 may be constructed from any conductive material, which may be transparent.

As shown in FIG. 11A, smart contact lens 1100 may include one or more switches 1114 that are configured to dynamically or optionally connect two or more of electrodes and/or antennae 1104, 1106, 1108, and/or 1110 so that the two or more of electrodes and/or antennae 1104, 1106, 1108, and/or 1110 act as a single electrode and/or antenna. For example, switch 1114A may connect electrodes and/or antennae 1104 and 1108 such that they act as a single electrode and/or antenna, switch 1114B may connect electrodes and/or antennae 1108 and 1110 such that they act as a single electrode and/or antenna, and switch 1114C may connect electrodes and/or antennae 1106 and 1110 such that they act as a single electrode and/or antenna. In at least one embodiment, switches 1114 may connect electrodes and/or antennae 1104, 1106, 1108, and 1110 such that they act as a single electrode and/or antenna. Switches 1114 may be Complementary Metal-Oxide-Semiconductor (CMOS) switches, thin-film switches, and/or any other suitable switch. As shown in FIG. 11B, electrodes and/or antennae 1104, 1106, 1108, and/or 1110 may be coupled to a medial surface 1116 and/or a lateral surface 1118 of smart contact lens 1100. In the illustrated embodiment, medial surface 1116 may include electrodes and/or antennae 1104B and 1108B positioned to rest against or near a user's eye, and/or lateral surface 1118 of smart contact lens 1100 may include electrodes and/or antennae 1104A and 1108A positioned to face away from the user's eye.

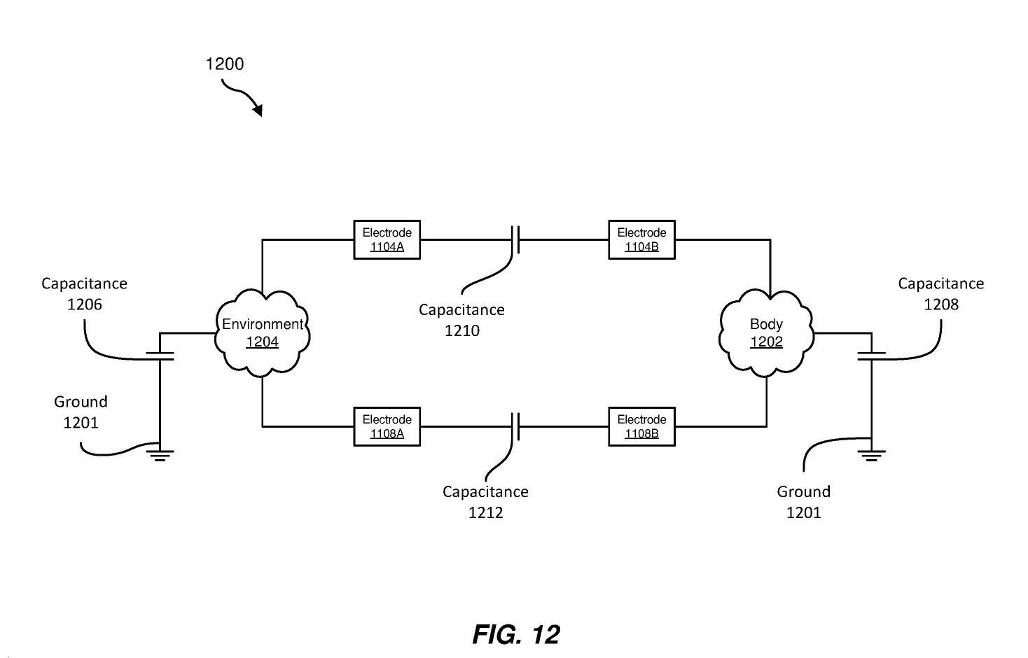

FIG. 12 illustrates an exemplary approximated model 1200 of some of the interactions of smart contact lens 1100 in FIG. 11, a body 1202 of a user, an environment 1204 of the user, and ground 1201. As illustrated in FIG. 12, a capacitance 1206 may represent a capacitance between electrodes and/or antennae 1104A and 1108A and ground 1201, and a capacitance 1208 may represent a capacitance between electrodes and/or antennae 1104B and 1108B and ground 1201. Additionally, a capacitance 1210 may represent a capacitance between electrode and/or antenna 1104A and electrode and/or antenna 1104B, which is in contact with body 1202, and a capacitance 1212 may represent a capacitance between electrode and/or antenna 1108A and electrode and/or antenna 1108B, which is in contact with body 1202.

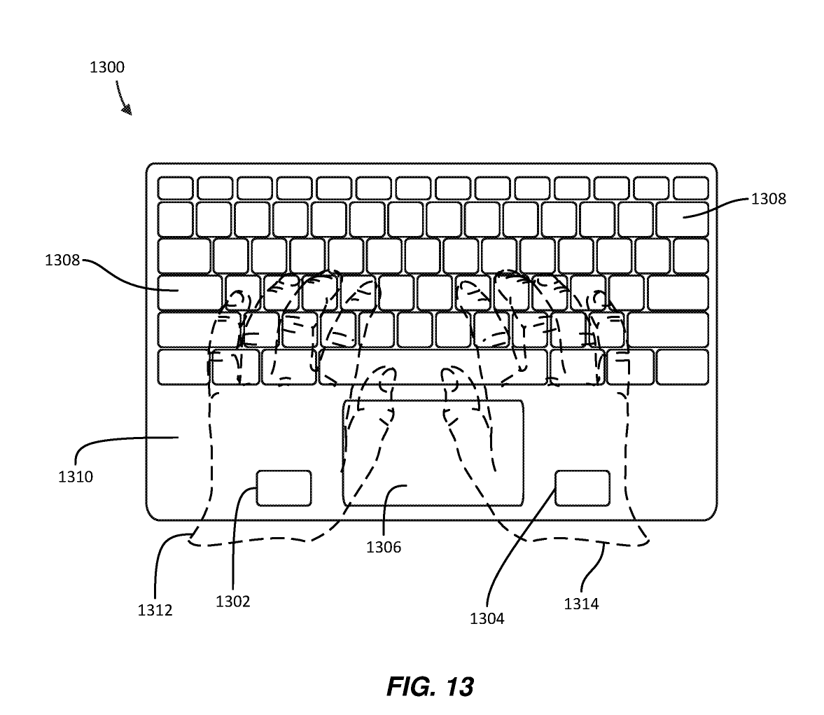

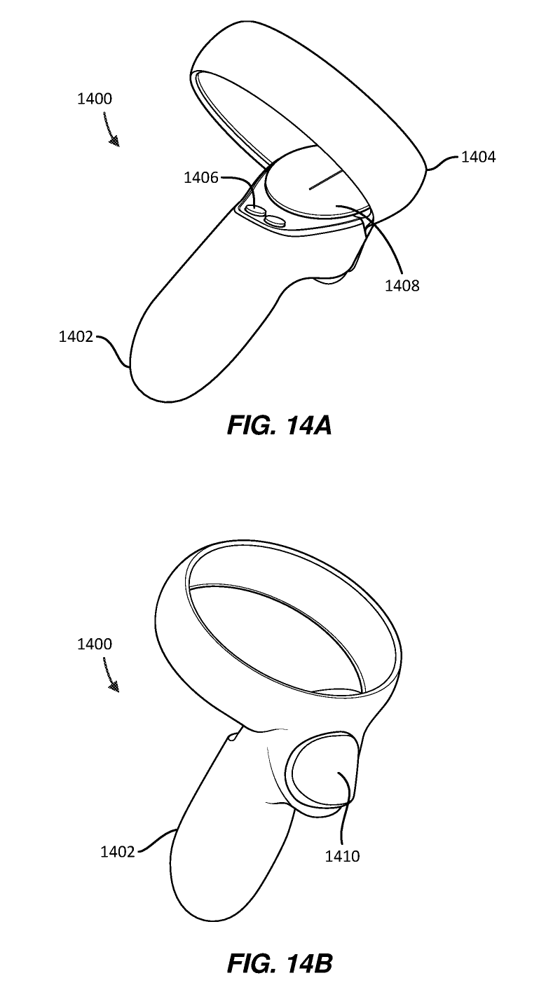

FIGS. 13, 14A, and 14B illustrate various exemplary processing devices according to some embodiments. FIG. 13 is a top view of a keyboard 1300 that may process data for a head-mounted device and transmit a result of processing the data back to the head-mounted device via a user's body as the user is interacting with keyboard 1300. In some embodiments, keyboard 1300 may be a keyboard of a laptop or a desktop computing device that includes a processor for processing data. Whenever a user interacts with keyboard 1300, keyboard 1300 may receive data, process the data, and transmit a result of processing the data to a head-mounted device or other wearable devices worn by a user via electrodes or antennae incorporated into keyboard 1300.

Conductive elements for receiving and transmitting data via a user's body may be incorporated into keyboard 1300 at various locations. As shown, keyboard 1300 may include a left conductive element 1302, a right conductive element 1304, a touchpad 1306, keys 1308, and a top surface 1310. Left conductive element 1302 may be positioned relative to keys 1308 so that a left hand 1312 of a user will typically rest on left conductive element 1302 when the user interacts with keyboard 1300. Similarly, right conductive element 1304 may be positioned relative to keys 1308 so that a right hand 1314 of the user will typically rest on right conductive element 1304 when the user interacts with keyboard 1300. In addition to or as an alternative to left conductive element 1302 and right conductive element 1304, one or more additional conductive elements may be incorporated into other surfaces of keyboard 1300 with which the user is likely to touch or contact. For example, conductive elements may be incorporated in touchpad 1306, one or more of keys 1308, and/or some or all of top surface 1310.

FIGS. 14A and 14B are perspective views of a hand-held controller 1400 of a head-mounted display system in accordance with various embodiments. In some examples, a head-mounted display system may include two hand-held controllers 1400, with one hand-held controller 1400 for each of a user's right and left hands. Each hand-held controller 1400 may be communicatively coupled to a head-mounted display device via the body of a user.

As shown in FIG. 14, hand-held controller 1400 may include a grip 1402 sized to fit within a user's right or left hand. Hand-held controller 1400 may also include a tracking loop 1404 for tracking a position and orientation of hand-held controller 1400. For example, tracking loop 1404 may include an array of tracking lights, such as LEDs, that are used in conjunction with a sensor (not shown) for motion and positional tracking purposes to provide 360-degree motion control while using a head-mounted display system. Hand-held controller 1400 may additionally include one or more input features (e.g., button, trigger, joystick, touchpad, etc.) for receiving input from a user. For example, hand-held controller 1400 may include buttons 1406 that may be depressed by the user's thumb to activate a corresponding switch and/or sensor. Additionally, hand-held controller 1400 may include a touchpad 1408 that includes, for example, sensors (e.g., capacitive sensors, conductive sensors, resistive sensors, etc.) that detect the position and/or directional movement of a user's thumb. In some embodiments, touchpad 1408 may be depressed by a user at one or more locations in the same manner as a button to provide additional input by activating one or more switches and/or sensors. Hand-held controller 1400 may also include a trigger 1410, which is a button that may be depressed by a user's finger (e.g., index finger) to activate a switch and/or sensor, on a side of hand-held controller 1400 opposite buttons 1406 and touchpad 1408. Additionally or alternatively, hand-held controller 1400 may include one or more other buttons, triggers, touchpads, and/or any other suitable input features, such as, for example, an analog stick (e.g., thumbstick) and/or a control pad (e.g., directional pad), without limitation. One or more conductive elements for receiving and transmitting data via a user's body may be utilized in any suitable portion of hand-held controller 1400, without limitation, including, for example, one or more portions of grip 1402, tracking loop 1404, one or more of buttons 1406, touchpad 1408, and/or trigger 1410.

FIG. 15 is a flow diagram of an exemplary computer-implemented method 1500 for transmitting and receiving wireless low-power communications between devices worn or contacted by users. The steps shown in FIG. 15 may be performed by any suitable computer-executable code and/or computing system, including the devices illustrated in FIGS. 1-14B. In one example, each of the steps shown in FIG. 15 may represent an algorithm whose structure includes and/or is represented by multiple sub-steps, examples of which will be provided in greater detail below.

As illustrated in FIG. 15, at step 1510 one or more of the systems described herein may modulate a body-bound carrier signal with data. For example, transmitting subsystem 112 of head-mounted device 102 in FIG. 1 may modulate a body-bound carrier signal with data 110. In another example, transmitting subsystem 212 of head-mounted device 202 in FIG. 2 may modulate a body-bound carrier signal with data 210.

In some examples, a transmitting subsystem of a wearable device may generate a body-bound carrier signal for transmitting data through a user's body by converting a voltage (e.g., a DC voltage) to an oscillating signal (e.g., a sine-wave signal) and modulating the oscillating signal with the data. The transmitting subsystem may select any suitable frequency for the oscillating or alternating voltage that generates body-bound carrier signals that are able to travel through a user's body with low transmission loss. For example, the transmitting subsystem may select a frequency between about 1 kHz and 150 MHz for the oscillating or alternating voltage. In other examples, the transmitting subsystem may select a frequency between about 1 MHz and 100 MHz for the oscillating or alternating voltage. The systems described herein may modulate a body-bound carrier signal with data using any suitable modulation technique. For example, a transmitting subsystem may modulate a body-bound carrier signal with data using Amplitude-Shift Keying (ASK), Frequency-Shift Keying (FSK), Phase-Shift Keying (PSK) (e.g., Binary Phase-Shift Keying (BPSK)), Quadrature Amplitude Modulation (QAM), and/or any other suitable modulation technique.

As illustrated in FIG. 15, at step 1520 one or more of the systems described herein may transmit, through a user's body via a human-body coupler, the data to an auxiliary processing device for processing. For example, transmitting subsystem 112 of head-mounted device 102 in FIG. 1 may transmit data 110 to processing device 106 for processing by galvanically transmitting a body-bound carrier signal carrying data 110 to processing device 106 through the body of user 104. In another example, transmitting subsystem 212 of head-mounted device 202 in FIG. 2 may transmit data 210 to processing device 206 by capacitively transmitting a body-bound carrier signal carrying data 210 to processing device 206 through the body of user 204.

The systems described herein may perform step 1520 in a variety of ways. In general, a transmitting subsystem may transmit a body-bound carrier signal through a user's body by applying the body-bound carrier signal across two electrically isolated electrodes of a human-body coupler to induce a current or an electric field within the user's body. For example, transmitting subsystem 112 of head-mounted device 102 in FIG. 1 may galvanically transmit a body-bound carrier signal carrying data 110 to processing device 106 through the body of user 104 by applying the body-bound carrier signal to human-body coupler 120. In another example, transmitting subsystem 212 of head-mounted device 202 in FIG. 2 may capacitively transmit a body-bound carrier signal carrying data 210 to processing device 206 through the body of user 204 by applying the body-bound carrier signal to human-body coupler 220.

As illustrated in FIG. 15, at step 1530 one or more of the systems described herein may receive, through the user's body via the human-body coupler, an additional body-bound carrier signal from the auxiliary processing device. For example, receiving subsystem 114 of head-mounted device 102 in FIG. 1 may galvanically receive a body-bound carrier signal carrying result 116 from processing device 106. In another example, receiving subsystem 214 of head-mounted device 202 in FIG. 2 may capacitively receive a body-bound carrier signal carrying result 216 sent from processing device 206.

The systems described herein may perform step 1530 in a variety of ways. In general, a receiving subsystem of a body-connected device may receive a body-bound carrier signal through a user's body by conducting an oscillating current generated by an oscillating or alternating voltage found across two electrically isolated electrodes of a human-body coupler. This oscillating or alternating voltage may be caused by a body-bound carrier signal transmitted by another body-connected device. In some examples, a receiving subsystem of a body-connected device may include a resonator or resonant circuit that is configured to resonate at a frequency of a body-bound carrier signal sent through a user's body. In these examples, the receiving subsystem may use the resonator to receive an oscillating or alternating signal found across two electrically isolated electrodes of a human-body coupler. For example, receiving subsystem 114 of head-mounted device 102 in FIG. 1 may galvanically receive a body-bound carrier signal carrying result 116 by conducting the body-bound carrier signal from the body of user 104 via electrodes 122 and 124 of human-body coupler 120. In another example, receiving subsystem 214 of head-mounted device 202 in FIG. 2 may capacitively receive a body-bound carrier signal carrying result 216 by conducting the body-bound carrier signal from the body of user 204 via electrodes 222 and 224 of human-body coupler 220.

As illustrated in FIG. 15, at step 1540 one or more of the systems described herein may demodulate a result of processing the data from the additional body-bound carrier signal. For example, receiving subsystem 114 of head-mounted device 102 in FIG. 1 may demodulate result 116 of processing data 110 from a body-bound carrier signal sent from processing device 106 through the body of user 104. In another example, receiving subsystem 214 of head-mounted device 202 in FIG. 2 may demodulate result 216 of processing data 210 from a body-bound carrier signal sent from processing device 206 through the body of user 204. The systems described herein may use any suitable demodulation technique or method to demodulate data from a body-bound carrier signal.

As illustrated in FIG. 15, at step 1550 one or more of the systems described herein may output the result to the user. For example, output device 118 of head-mounted device 102 in FIG. 1 may present or display result 116 to user 104. In another example, output device 218 of head-mounted device 202 in FIG. 2 may present or display result 216 to user 204.

FIG. 16 is a flow diagram of an exemplary computer-implemented method 1600 for low-power backscatter communications between devices worn or contacted by users. The steps shown in FIG. 16 may be performed by any suitable computer-executable code and/or computing system, including the devices illustrated in FIGS. 1-14B. In one example, each of the steps shown in FIG. 16 may represent an algorithm whose structure includes and/or is represented by multiple sub-steps, examples of which will be provided in greater detail below.

As illustrated in FIG. 16, at step 1610 one or more of the systems described herein may modulate, at a wearable device that includes at least one antenna configured to reflect ambient carrier signals into a user's body, a backscatter control signal with data generated at the wearable device. For example, backscatter modulator 314 of wearable device 302 in FIG. 3 may modulate backscatter control signal 315 with data 312.

In some examples, a backscatter modulator of a wearable device may transmit data through a user's body by converting a voltage (e.g., a DC voltage) to an oscillating backscatter control signal (e.g., a sine-wave signal) and modulating the oscillating backscatter control signal with the data. The systems described herein may modulate a backscatter control signal with data using any suitable modulation technique and/or transmission protocol. For example, a backscatter modulator may modulate a backscatter control signal with data using Amplitude-Shift Keying (ASK), Frequency-Shift Keying (FSK), Phase-Shift Keying (PSK) (e.g., Binary Phase-Shift Keying (BPSK)), Quadrature Amplitude Modulation (QAM), and/or any other suitable modulation technique. The backscatter modulator may also select any suitable frequency for the oscillating or alternating voltage that generates backscattered ambient carrier signals (i.e., frequency-shifted signals) that are able to travel through a user's body with low transmission loss. For example, the backscatter modulator may select a frequency for the oscillating or alternating voltage that results in backscattered ambient carrier signals having frequencies between about 1 kHz and 150 MHz. In other examples, the backscatter modulator may select a frequency for the oscillating or alternating voltage that results in backscattered ambient carrier signals having frequencies between about 1 MHz and 100 MHz.

As illustrated in FIG. 16, at step 1620 one or more of the systems described herein may transmit the data from the wearable device to an auxiliary processing device by using, at the wearable device, the backscatter control signal to cause the antenna to backscatter an ambient carrier signal from the user's environment through the user's body. For example, backscatter modulator 314 of wearable device 302 in FIG. 3 may transmit data 312 to processing device 306 for processing by using backscatter control signal 315 to cause antenna 318 to backscatter ambient carrier signal 301 into the body of user 304 as body-bound carrier signal 303.

The systems described herein may perform step 1620 in a variety of ways. In general, a backscatter modulator may use a backscatter control signal to cause an antenna to backscatter an ambient carrier signal from a user's environment through the user's body by using the backscatter control signal to modulate the load impedance of the antenna. The modulation of the load impedance of the antenna may cause the ambient carrier signal to be alternatingly reflected into the body of the user and absorbed by the antenna, which may modulate the reflected portion of the ambient carrier signal to carry the data. The reflected portion of the ambient carrier signal may then propagate through the body of the user until it is absorbed by another antenna of another device worn or contacted by the user.

As explained above, embodiments of the instant disclosure may enable a head-mounted device, such as a head-mounted display or a smart contact lens, to efficiently transmit data through a wearer's body to other remote processing devices (e.g., smart phones, smart watches, and/or laptop or desktop computers) worn or contacted by the wearer. By using a wearer's body as a low-loss communication medium, embodiments of the instant disclosure may enable wireless head-mounted devices to securely transmit and receive data using less power and at higher bandwidths when compared to devices that use only a wearer's environment (e.g., air surrounding the wearer) to transfer and receive data.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the subsystems or modules described herein may transform data, physical devices, and/or representations of physical devices from one form to another. For example, one or more of the subsystems or modules recited herein may receive data from a data source of a wearable device, transform the data into a body-bound carrier signal suitable for transmission through a user's body, output a result of the transformation to a human-body coupler configured to apply the body-bound carrier signal to the user's body, and/or use the result of the transformation to transfer the data to an auxiliary processing device for processing. Additionally or alternatively, one or more of the subsystems or modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A head-mounted device comprising:
a data source that generates data;
a human-body coupler configured to apply body-bound carrier signals to a user's body and conduct body-bound carrier signals from the user's body, the human-body coupler comprising a first electrode and a second electrode;
a transmitting subsystem electrically connected to the human-body coupler and configured to:
modulate a body-bound carrier signal with the data; and
transmit, through the user's body via the human-body coupler, the data to an auxiliary processing device for processing;
a receiving subsystem electrically connected to the human-body coupler and configured to:
receive, through the user's body via the human-body coupler, an additional body-bound carrier signal from the auxiliary processing device; and
demodulate a result of processing the data from the additional body-bound carrier signal; and
an output device configured to output the result to the user.

2. The head-mounted device of claim 1, wherein:
the human-body coupler is capacitively coupled to the user's body;
the head-mounted device further comprises:
a medial surface that faces the user's head when the head-mounted device is worn by the user;
a lateral surface that faces away from the user's head when the head-mounted device is worn by the user;
the first electrode is coupled to the medial surface of the head-mounted device such that the first electrode contacts the user's head; and
the second electrode is coupled to the lateral surface of the head-mounted device such that the second electrode contacts air surrounding the user's body.

3. The head-mounted device of claim 1, wherein:
the human-body coupler is galvanically coupled to the user's body;
the head-mounted device further comprises a medial surface that faces the user's head when the head-mounted device is worn by the user;
the first electrode is coupled to the medial surface of the head-mounted device such that the first electrode contacts the user's head; and
the second electrode is coupled to the medial surface of the head-mounted device such that the second electrode contacts the user's head.

4. The head-mounted device of claim 1, wherein the head-mounted device is a head-mounted display device.

5. The head-mounted device of claim 4, wherein:
the head-mounted display device further comprises a facial-interface cushion dimensioned to abut a facial portion of the user; and
the first electrode forms an integral part of the facial-interface cushion.

6. The head-mounted device of claim 4, wherein:
the output device is a display;
the head-mounted display device further comprises:
a bridge coupled to the display and dimensioned to rest on the nose of the user; and
a temple coupled to the display and dimensioned to rest on an ear of the user; and
the first electrode forms an integral part of one of:
the bridge; or
the temple.

7. The head-mounted device of claim 1, wherein the head-mounted device is a smart contact lens configured to enhance the user's vision.

8. A wearable device comprising:
a data source that generates data;
at least one antenna configured to reflect ambient carrier signals from a user's environment into the user's body; and
a backscatter modulator electrically connected to the antenna and configured to use an ambient carrier signal from the user's environment to backscatter, through the user's body via the antenna, the data to an auxiliary processing device.

9. The wearable device of claim 8, wherein the backscatter modulator is further configured to frequency shift an initial frequency of the ambient carrier signal to a secondary frequency suitable for propagating through the user's body to the auxiliary processing device.

10. The wearable device of claim 9, wherein the secondary frequency is between 1 kilohertz and 100 megahertz.

11. The wearable device of claim 10, wherein the ambient carrier signal comprises one of:
a frequency-modulated radio broadcast signal;
an amplitude-modulated radio broadcast signal;
a television broadcast signal;
a wi-fi signal;
a Bluetooth signal;
an industrial, scientific and medical radio band signal; or
a cellular radio signal.

12. The wearable device of claim 8, further comprising:
a human-body coupler configured to conduct body-bound carrier signals from the user's body, the human-body coupler comprising a first electrode and a second electrode;
a receiving subsystem electrically connected to the human-body coupler and configured to:
receive, through the user's body via the human-body coupler, a body-bound carrier signal from the auxiliary processing device; and
demodulate a result of processing the data from the body-bound carrier signal; and
an output device configured to output the result to the user.

13. The wearable device of claim 12, wherein:
the human-body coupler is capacitively coupled to the user's body;
the wearable device further comprises:
a medial surface that faces the user's body when the wearable device is worn by the user; and
a lateral surface that faces away from the user's body when the wearable device is worn by the user;
the first electrode is coupled to the medial surface of the wearable device such that the first electrode contacts the user's body; and
the second electrode is coupled to the lateral surface of the wearable device such that the second electrode contacts air surrounding the user's body.

14. The wearable device of claim 12, wherein:
the human-body coupler is galvanically coupled to the user's body;
the wearable device further comprises a medial surface that faces the user's body when the wearable device is worn by the user;
the first electrode is coupled to the medial surface of the wearable device such that the first electrode contacts the user's body; and
the second electrode is coupled to the medial surface of the wearable device such that the second electrode contacts the user's body.

15. The wearable device of claim 8, wherein the wearable device is a head-mounted display device.

16. The wearable device of claim 8, wherein the wearable device is a smart contact lens configured to enhance the user's vision.

17. A computer-implemented method comprising:
modulating, at a wearable device, a backscatter control signal with data generated at the wearable device, wherein the wearable device comprises at least one antenna configured to reflect ambient carrier signals into a user's body; and
transmitting the data from the wearable device to an auxiliary processing device by using, at the wearable device, the backscatter control signal to cause the antenna to backscatter an ambient carrier signal from the user's environment through the user's body.

18. The computer-implemented method of claim 17, further comprising using the backscatter control signal to frequency shift an initial frequency of the ambient carrier signal to a secondary frequency suitable for propagating through the user's body to the auxiliary processing device.

19. The computer-implemented method of claim 18, wherein the secondary frequency is between 1 kilohertz and 100 megahertz.

20. The computer-implemented method of claim 19, wherein the ambient carrier signal comprises one of:
a frequency-modulated radio broadcast signal;
an amplitude-modulated radio broadcast signal;
a television broadcast signal;
a wi-fi signal;
a Bluetooth signal;
an industrial, scientific and medical radio band signal; or
a cellular radio signal.
